(19) United States
(12) Patent Application Publication
(10) Pub. No.: US 2026/0322957 A1
(43) Pub. Date: Oct. 15, 2026

(54) CORRECTION METHOD AND PROJECTION APPARATUS

(71) Applicant: SEIKO EPSON CORPORATION, Tokyo (JP)

(72) Inventor: Yutaro IIJIMA, MATSUMOTO-SHI (JP)

(21) Appl. No.: 19/644,542

(22) Filed: Apr. 10, 2026

(30) Foreign Application Priority Data
Apr. 11, 2025 (JP) 2025-065587

(51) Int. Cl. H04N 9/31; G06T 7/521

(52) U.S. Cl. CPC H04N 9/3179; G06T 7/521; H04N 9/3191

(57) ABSTRACT

A controller of a first projection apparatus acquires depth information indicating a distance from a distance sensor to each of multiple positions on a projection receiving surface based on an output from the distance sensor, the distance sensor including a light emitter configured to irradiate the projection receiving surface with radiation light and a light receiver having multiple light receiving regions configured to receive reflected light that is the radiation light reflected off the projection receiving surface; selects at least one of the multiple light receiving regions based on the depth information; generates a parameter that specifies the projection receiving surface based on the depth information provided when the selected light receiving region receives the reflected light; and corrects a projection image based on the parameter that specifies the projection receiving surface.

The present application is based on, and claims priority from JP Application Serial Number 2025-065587, filed Apr. 11, 2025, the disclosure of which is hereby incorporated by reference herein in its entirety.

### BACKGROUND

### 1. Technical Field

The present disclosure relates to a correction method and a projection apparatus.

### 2. Related Art

In related art, there is a known technology for determining a normal vector with respect to a projection receiving surface based on the distance to the projection receiving surface measured with a distance sensor and correcting a projection image by using the determined normal vector.

For example, WO 2022/193560 discloses a projector that acquires information on the depths of multiple light points on a projection receiving surface by using a time-of-flight (ToF) sensor and determines a normal vector with respect to the projection receiving surface based on multiple pieces of the acquired depth information. The projector disclosed in WO 2022/193560 acquires information on the amount of offset of the projector based on the determined normal vector with respect to the projection receiving surface, and corrects a projection image based on the acquired offset information.

WO 2022/193560 is an example of the related art.

In the technology disclosed in WO 2022/193560, however, when the projection receiving surface inclines with respect to the ToF sensor by a large angle or when the ToF sensor is separate from the projection receiving surface by a long distance, the accuracy of the measurement of the information on the depths of the multiple light points may decrease. When the shape of the projection image to be projected onto the projection receiving surface is corrected based on the depth information measured at reduced accuracy, the result of the correction also deteriorates in some cases.

### SUMMARY

A correction method according to an aspect of the present disclosure is a method for correcting a projection image to be projected by a projection apparatus onto a projection receiving surface, the method including: acquiring depth information indicating a distance from a distance sensor to each of multiple positions on the projection receiving surface based on an output from the distance sensor, the distance sensor including a light emitter configured to irradiate the projection receiving surface with radiation light and a light receiver having multiple light receiving regions configured to receive reflected light that is the radiation light reflected off the projection receiving surface; selecting at least one of the multiple light receiving regions based on the depth information; generating a parameter that specifies the projection receiving surface based on the depth information provided when the selected light receiving region receives the reflected light; and correcting the projection image based on the parameter that specifies the projection receiving surface.

A correction method according to another aspect of the present disclosure is a method for correcting a projection image to be projected by a projection apparatus onto a projection receiving surface, the method including: projecting the projection image containing a test pattern onto the projection receiving surface via the projection apparatus; selecting at least one pattern contained in the test pattern based on an image captured by an imaging apparatus configured to capture an image of the projection receiving surface onto which the projection image containing the test pattern is projected; acquiring depth information indicating a distance to the projection receiving surface based on a position of a light receiving element configured to capture an image of the selected pattern out of light receiving elements provided in an imager of the imaging apparatus; generating a parameter that specifies the projection receiving surface based on the depth information; and correcting the projection image based on the parameter that specifies the projection receiving surface.

A projection apparatus according to another aspect of the present disclosure is a projection apparatus including: a projector configured to project a projection image onto a projection receiving surface; and one or more processors, and the one or more processors are configured to acquire depth information indicating a distance from a distance sensor to each of multiple positions on the projection receiving surface based on an output from the distance sensor, the distance sensor including a light emitter configured to irradiate the projection receiving surface with radiation light and a light receiver having multiple light receiving regions configured to receive reflected light that is the radiation light reflected off the projection receiving surface; select at least one of the multiple light receiving regions based on the depth information; generate a parameter that specifies the projection receiving surface based on the depth information provided when the selected light receiving region receives the reflected light; and correct the projection image based on the parameter that specifies the projection receiving surface.

A projection apparatus according to another aspect of the present disclosure is a projection apparatus including: a projector configured to project a projection image onto a projection receiving surface; and one or more processors, and the one or more processors are configured to project the projection image containing a test pattern onto the projection receiving surface via the projection apparatus; select at least one pattern contained in the test pattern based on an output from an imaging apparatus configured to capture an image of the projection receiving surface onto which the projection image containing the test pattern is projected; acquire depth information indicating a distance to the projection receiving surface based on a position of a light receiving element configured to capture an image of the selected pattern out of light receiving elements provided in an imager of the imaging apparatus; generate a parameter that specifies the projection receiving surface based on the depth information; and correct the projection image based on the parameter that specifies the projection receiving surface.

### BRIEF DESCRIPTION OF THE DRAWINGS

FIG. 1 is a block diagram showing the configuration of a projection apparatus according to a first embodiment.

FIG. 2 shows the configuration of a projector.

FIG. 3 shows multiple measurement positions on a projection receiving surface.

FIG. 4 shows the configuration of a light receiver provided in a distance sensor.

FIG. 5 shows an example of a depth information map and an intensity information map.

FIG. 6 shows the angle between the installed projection apparatus and projection receiving surface.

FIG. 7 shows a state in which the optical axis of the projection apparatus inclines by “θ1” in the horizontal direction with respect to a normal vector with respect to the projection receiving surface.

FIG. 8 shows a state in which the optical axis of the projection apparatus inclines by “θ2” in the horizontal direction with respect to the normal vector with respect to the projection receiving surface.

FIG. 9 is a flowchart showing a first operation of a first projection apparatus.

FIG. 10 is a flowchart showing a second operation of the first projection apparatus.

FIG. 11 shows depth information measured with the distance sensor and the depth information after scale conversion.

FIG. 12 is a block diagram showing the configuration of a projection apparatus according to a second embodiment.

FIG. 13 shows an example of a test pattern.

FIG. 14 is a flowchart showing a first operation of a second projection apparatus.

### DESCRIPTION OF EMBODIMENTS

### 1. Configuration of Projection Apparatus According to First Embodiment

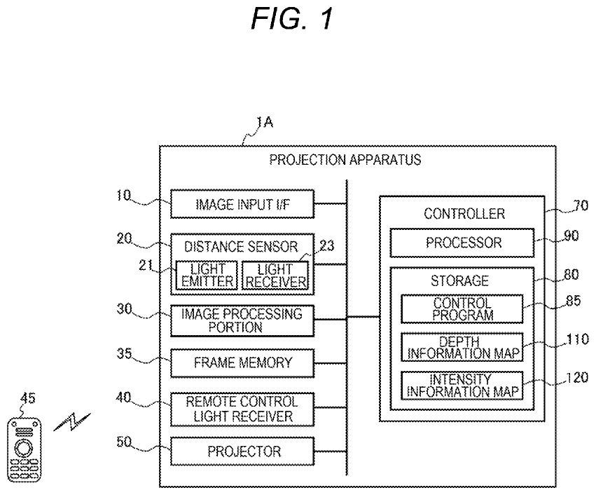

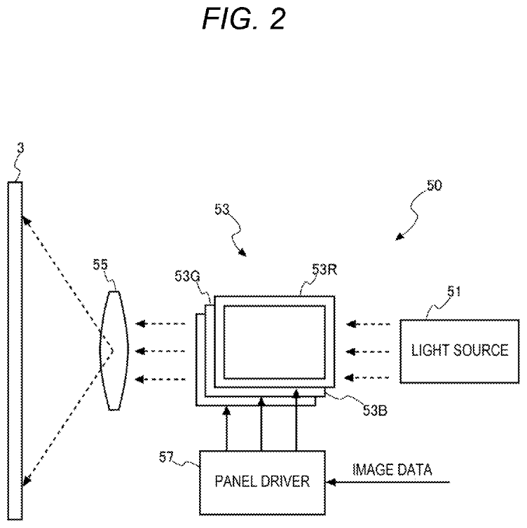

FIG. 1 is a block diagram showing the configuration of a first projection apparatus 1A according to a first embodiment, and FIG. 2 shows the configuration of a projector 50 provided in the first projection apparatus 1A. The configuration of the first projection apparatus 1A will be described with reference to FIGS. 1 and 2.

The first projection apparatus 1A includes an image input interface 10, a distance sensor 20, an image processing portion 30, a frame memory 35, a remote control light receiver 40, the projector 50, and a controller 70. An interface is hereinafter abbreviated to I/F.

The image input I/F 10 is an interface to which an image signal transmission cable can be coupled, such as a high-definition multimedia interface (HDMI) or a display port, and includes an interface circuit that conforms to a predetermined communication standard. HDMI is a registered trademark. An image signal supplied from an external apparatus that is not shown such as a personal computer is input to the image input I/F 10. The image input I/F 10 outputs image data contained in the input image signal to the image processing portion 30.

The distance sensor 20 measures the distance to a measurement target. The distance sensor 20 includes a light emitter 21, which radiates radiation light, and a light receiver 23 including multiple light receiving elements that receive reflected light that is the radiation light reflected off a projection receiving surface 3. The multiple light receiving elements correspond to light receiving regions. The distance sensor 20 irradiates the projection receiving surface 3, which is the measurement target, with the radiation light from a light emitting element provided in the light emitter 21 of the distance sensor 20, and receives reflected light that is the radiated radiation light reflected off the projection receiving surface 3 via the multiple light receiving elements. The distance sensor 20 measures the distances between the distance sensor 20 and multiple measurement positions on the projection receiving surface 3 based on the result of the reception of the reflected light via the multiple light receiving elements, and outputs sensor data indicating the result of the measurement to the controller 70. The controller 70 causes a storage 80, which will be described later, to store the sensor data input from the distance sensor 20. The present embodiment will be described with reference to a case where a ToF sensor is used as the distance sensor 20, but the distance sensor 20 may be another sensor such as a light-detection-and-ranging (LiDAR) sensor.

The light receiver 23 has a configuration in which the multiple light receiving elements are regularly arranged at a light receiving surface. The lateral direction of the light receiving surface is defined as an x-axis, and the longitudinal direction of the light receiving surface is defined as a y-axis. The light receiver 23 includes six light receiving elements in each of the x-axis direction and the y-axis direction. The number of the light receiving elements provided in the light receiver 23, that is, the resolution thereof is therefore six elements×six elements.

The frame memory 35 is coupled to the image processing portion 30. The frame memory 35 has multiple banks. The banks each have a storage capacity that allows image data corresponding to one frame to be written into the bank. The frame memory 35 is configured, for example, with a synchronous dynamic random access memory (SDRAM). The image processing portion 30 loads the image data input from the image input I/F 10 into the frame memory 35.

The image processing portion 30 performs image processing on the image data loaded into the frame memory 35. Examples of the image processing performed by the image processing portion 30 may include resolution conversion or resizing, distortion correction, shape correction, digital zooming, and adjustment of the tint and luminance of an image. The image processing portion 30 performs processing specified by the controller 70, and performs the processing by using a parameter input from the controller 70 as necessary. The image processing portion 30 can, of course, perform some of the multiple types of image processing described above in combination. The image processing portion 30 reads, from the frame memory 35, the image data loaded into a bank selected by the controller 70 and outputs the read image data to the projector 50.

The image processing portion 30 and the frame memory 35 are each configured, for example, with an integrated circuit. Examples of the integrated circuit may include a large scale integration (LSI) circuit, an application specific integrated circuit (ASIC), a programmable logic device (PLD), a field-programmable gate array (FPGA), a system-on-a-chip (SoC), and the like. The integrated circuit may include an analog circuit as a portion of the configuration thereof, or the controller 70 and the integrated circuit may be combined with each other.

The remote control light receiver 40 receives an infrared signal transmitted from a remote control 45. The remote control 45 includes multiple buttons such as a power button, a source switching button, a volume button, a projection start button, and a projection end button. The remote control 45 transmits an infrared signal corresponding to a button operated by a user to the first projection apparatus 1A. The remote control light receiver 40 outputs an operation signal corresponding to the received infrared signal to the controller 70. The operation signal is a signal corresponding to a button of the remote control 45 operated by the user.

FIG. 2 shows the configuration of the projector 50.

The configuration of the projector 50 will now be described with reference to FIG. 2.

The projector 50 modulates light output from a light source 51 to generate image light, enlarges and projects the generated image light via an optical unit 55. The projector 50 includes the light source 51, three liquid crystal panels 53R, 53G, and 53B serving as light modulators, the optical unit 55, and a panel driver 57. The liquid crystal panels 53R, 53G, and 53B provided in the projector 50 may be hereinafter collectively referred to as liquid crystal panels 53.

The light source 51 includes a discharge-type light source lamp such as an ultrahigh-pressure mercury lamp or a metal halide lamp, or a solid-state light source such as a light emitting diode or a semiconductor laser. The light output from the light source 51 is incident on the liquid crystal panels 53. The liquid crystal panels 53R, 53G, and 53B are each configured, for example, with a transmissive liquid crystal panel in which a liquid crystal material is encapsulated between a pair of transparent substrates. The liquid crystal panel 53R modulates red light, the liquid crystal panel 53G modulates green light, and the liquid crystal panel 53B modulates blue light. Each of the liquid crystal panels has a pixel region including multiple pixels arranged in a matrix, and is configured to apply a drive voltage to the liquid crystal material on a pixel basis.

The image data output by the image processing portion 30 is input to the panel driver 57. The panel driver 57 applies a drive voltage according to the input image data to each of the pixels in the pixel region to set the pixel to have light transmittance according to the image data. The light output from the light source 51 is modulated on a pixel basis when passing through the pixel regions of the liquid crystal panels 53R, 53G, and 53B, so that image light corresponding to the image data is formed on a color light basis. The multiple types of thus formed color image light are combined with one another on a pixel basis by a light combining system that is not shown into image light representing a color image. The optical unit 55 includes a projection lens, enlarges the image light modulated by the liquid crystal panels 53R, 53G, and 53B, and projects the enlarged image light onto the projection receiving surface 3.

Returning to FIG. 1, the description of the configuration of the first projection apparatus 1A will be resumed.

The controller 70 is a computer apparatus including the storage 80 and a processor 90.

The storage 80 includes at least a nonvolatile semiconductor memory. The storage 80 may include a volatile semiconductor memory or an auxiliary storage device in addition to the nonvolatile semiconductor memory. The storage 80 stores a control program 85, the sensor data indicating a result of the measurement performed by the distance sensor 20, a depth information map 110, an intensity information map 120, and various setting data. The depth information map 110 and the intensity information map 120 will be described later.

The processor 90 is an arithmetic processing device including a central processing unit (CPU) or a micro-processing unit (MPU). The processor 90 may be configured with a single processor or multiple processors. The processor 90 may instead be configured with an SoC integrated with a portion or the entirety of the storage 80 or any other circuit. The processor 90 may be a combination of a CPU that executes a program and a digital signal processor (DSP) that performs predetermined arithmetic processing. Furthermore, all functions of the processor 90 may be implemented in hardware, or a programmable device may be used to realize the functions.

### 2. Operation of Projection Apparatus

The sensor data indicating a result of the measurement performed by the distance sensor 20 will first be described.

The sensor data output by the distance sensor 20 contains depth information DI and intensity information SI. The depth information DI is information indicating the distances from the distance sensor 20 to the multiple measurement positions on the projection receiving surface 3. The intensity information SI is information indicating the received light intensity of the reflected light received by the distance sensor 20. The reflected light is the radiation light radiated by the distance sensor 20 and reflected off the projection receiving surface 3. The sensor data further contains information on the angle of incidence of the reflected light incident on the light receiving elements.

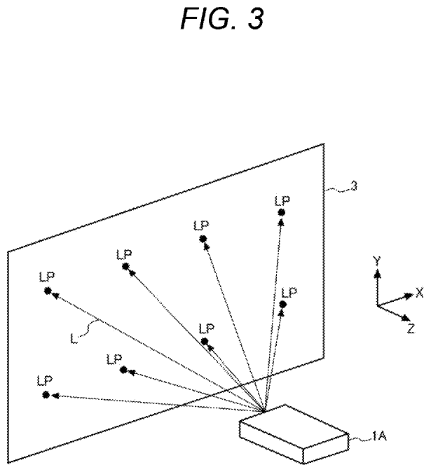

FIG. 3 shows the multiple measurement positions on the projection receiving surface 3.

FIG. 3 shows a state in which the first projection apparatus 1A and the projection receiving surface 3 are installed in an XYZ coordinate system, which is a world coordinate system. The Y-axis of the XYZ coordinate system corresponds to the vertical direction, and the X-axis and the Z-axis correspond to the horizontal direction. The optical axis of the first projection apparatus 1A is substantially parallel to the Z-axis. The optical axis of the first projection apparatus 1A is the optical axis of the projection lens provided in the optical unit 55. Note that the term “being substantially parallel” means being parallel with an error that falls within an allowable range. When the distance sensor 20 is a ToF sensor, the distance sensor 20 irradiates the multiple measurement positions on the projection receiving surface 3 with multiple line laser beams L. The multiple line laser beams L with which the projection receiving surface 3 is irradiated form multiple light points LP on the projection receiving surface 3. The multiple positions on the projection receiving surface 3 where the light points LP are formed correspond to “multiple positions”. The distance sensor 20 outputs the depth information DI indicating the multiple distances from the distance sensor 20 to the multiple light points LP formed on the projection receiving surface 3 based on a period from the time at which the distance sensor 20 radiates the line laser beams L to the time at which the multiple light receiving elements provided in the distance sensor 20 detect reflected light from the multiple light points LP. FIG. 3 shows a case where the light points LP are formed at 8 positions out of 36 positions on the projection receiving surface 3, which is the largest number of positions at which the distance sensor 20 can perform the detection.

The distance sensor 20 may irradiate the projection receiving surface 3 with planar laser light from a surface emitting laser instead of irradiating the projection receiving surface 3 with the multiple linear laser beams L as described above. In this case, the multiple light receiving elements discretely disposed in the light receiver 23 of the distance sensor 20 sense the reflected light from the projection receiving surface 3.

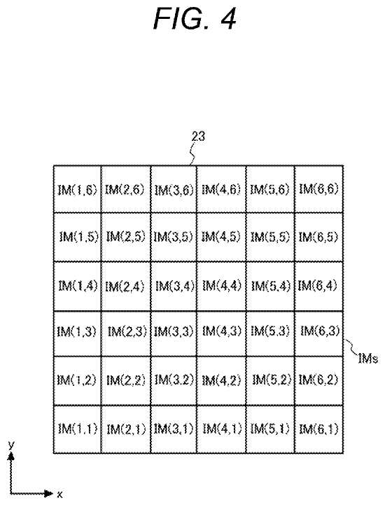

FIG. 4 shows the configuration of the multiple light receiving elements provided in the light receiver 23 of the distance sensor 20. The multiple light receiving elements correspond to the light receiving regions. The distance sensor 20 has a configuration in which six light receiving elements are regularly arranged in each of the x-axis direction and the y-axis direction, as shown in FIG. 4. The multiple light receiving elements provided in the light receiver 23 are collectively referred to as an element group IMs. The element group IMs is configured with 36 light receiving elements IM(1,1) to IM(6,6), as shown in FIG. 4. Note that the numbers in the parentheses are identification numbers used to identify the light receiving elements arranged in the x-axis direction and the y-axis direction. In FIG. 4, the lower left light receiving element is referred to as IM(1,1), and the upper right light receiving element is referred to as IM(6,6). The light receiving elements arranged in the same row as the IM(1,1) are assigned the same identification number indicating the position in the y-axis direction, such as IM(2,1), IM(3,1), IM(4,1), IM(5,1), and IM(6,1). The light receiving elements arranged in the same column as the IM(1,1) are assigned the same identification number indicating the position in the x-axis direction, such as IM(1,2), IM(1,3), IM(1,4), IM(1,5), and IM(1,6). The same applies to the other light receiving elements disposed at the light receiving surface.

Let n be a variable indicating the number of times the distance sensor 20 performs the measurement. Note that n is any natural number. The controller 70 acquires the sensor data from the distance sensor 20 n times (multiple times). That is, the sensor data measured at multiple different points in time are acquired. The sensor data from the 36 light receiving elements produced in the first measurement is referred to as a first frame, and the sensor data produced in the n-th measurement is referred to as an n-th frame.

The depth information from the light receiving element IM(1,1) in the first frame is referred to as DI(1,1,1), and the depth information from the light receiving element IM(1,1) in the n-th frame is referred to as DI(1,1, n). The first and second numerals out of the numerals shown in the parentheses are identification numbers used to identify the pixel disposed at a corresponding position in the x-axis direction and the y-axis direction, and the third numeral is an identification number used to identify the frame. Similarly, the intensity information from the light receiving element IM(1,1) in the first frame is referred to as SI(1,1,1), and the intensity information from the light receiving element IM(1,1) in the n-th frame is referred to as SI(1,1,n).

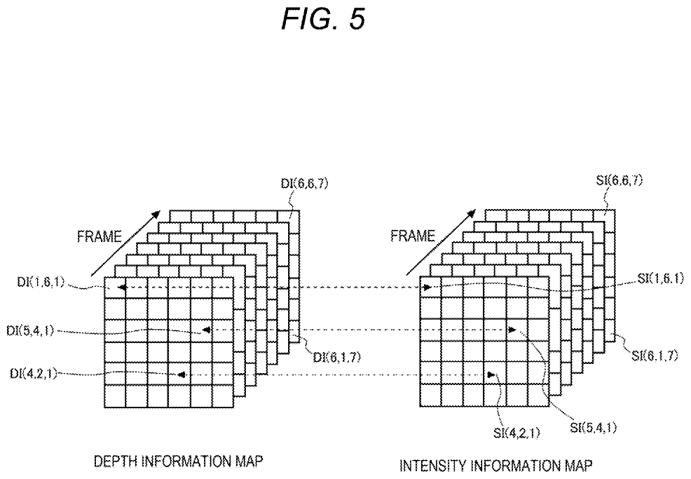

FIG. 5 shows a depth information map 110 and an intensity information map 120 generated by the controller 70. The controller 70 generates the depth information map 110 and the intensity information map 120 based on the sensor data input from the distance sensor 20.

The depth information map 110 is configured with n frames from the first frame to the n-th frame. The depth information map 110 of the first frame contains the depth information DI(1,1,1) to DI(6,6,1) from the light receiving elements IM(1,1) to IM(6,6) in the first frame. The depth information map 110 of the second frame contains the depth information DI(1,1,2) to DI(6,6,2) from the light receiving elements IM(1,1) to IM(6,6) in the second frame. The same applies to the depth information maps 110 of the third frame to the n-th frame.

The intensity information map 120 is configured with n frames from the first frame to the n-th frame. The intensity information map 120 of the first frame contains the intensity information SI(1,1,1) to SI(6,6,1) from the light receiving elements IM(1,1) to IM(6,6) in the first frame. The intensity information map 120 of the second frame contains the intensity information SI(1,1,2) to SI(6,6,2) from the light receiving elements IM(1,1) to IM(6,6) in the second frame. The same applies to the third frame to the n-th frame.

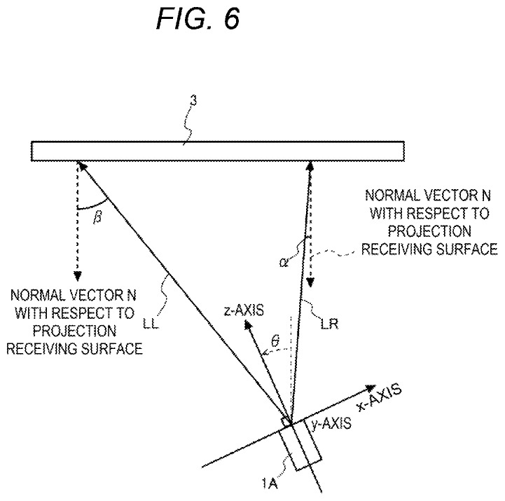

FIG. 6 shows the state in which the first projection apparatus 1A and the projection receiving surface 3 are installed. In more detail, FIG. 6 shows the state in which the first projection apparatus 1A and the projection receiving surface 3 are installed, the state viewed from above toward below in the y-axis direction.

The installation state shown in FIG. 6 is a state in which a normal vector N with respect to the projection receiving surface 3 is not parallel to the z-axis, which is the optical axis of the first projection apparatus 1A, and the optical axis of the first projection apparatus 1A is rotated counterclockwise by an angle θ in FIG. 6. The distance sensor 20 is installed so as to be oriented in parallel to the optical axis of the first projection apparatus 1A. That is, the optical axis of the first projection apparatus 1A is parallel to the optical axis of the distance sensor 20. Note that the optical axis of the first projection apparatus 1A may be replaced with the optical axis of the distance sensor 20. Furthermore, coordinate conversion may be performed by storing the optical axis of the distance sensor 20 with respect to the optical axis of the first projection apparatus 1A in the storage 80.

Out of the line laser beams L radiated by the distance sensor 20, a line laser beam LL radiated to the left side of the projection receiving surface 3 in FIG. 6 is incident on the projection receiving surface 3 at an angle of incidence 3. The angle of incidence B is an angle between the normal vector N with respect to the projection receiving surface 3 and the line laser beam LL.

Out of the line laser beams L radiated by the distance sensor 20, a line laser beam LR radiated to the right side of the projection receiving surface 3 in FIG. 6 is incident on the projection receiving surface 3 at an angle of incidence a. The angle of incidence a is an angle between the normal vector N with respect to the projection receiving surface 3 and the line laser beam LR.

Referring to FIG. 6, the angle of incidence S of the line laser beam LL with respect to the projection receiving surface 3 is greater than the angle of incidence a of the line laser beam LR, which is radiated to the right side of the projection receiving surface 3, with respect to the projection receiving surface 3. The greater the angle of incidence of a line laser beam L, which is the radiated light, with respect to the projection receiving surface 3, the lower the intensity of the reflected light returning to the distance sensor 20, so that the lower the accuracy of the measurement of the distance measured by the distance sensor 20.

Therefore, in the present embodiment, the normal vector with respect to the projection receiving surface 3 is first provisionally calculated based on the sensor data output by the distance sensor 20. Let N1 be the provisionally calculated normal vector with respect to the projection receiving surface 3. Next, based on the relationship between the provisionally calculated normal vector N1 with respect to the projection receiving surface 3 and the angles of incidence of the reflected light incident on the light receiving elements, the sensor data from light receiving elements used in final calculation of the normal vector with respect to the projection receiving surface 3 is selected. The normal vector with respect to the projection receiving surface 3 is then calculated based on the depth information DI from the selected light receiving element. Let N2 be the normal vector with respect to the projection receiving surface 3 provided by the final calculation.

The provisional calculation of the normal vector N1 with respect to the projection receiving surface 3 will first be described.

The controller 70 acquires the sensor data output by light receiving elements set in advance out of the entire sensor data. For example, the controller 70 may acquire the sensor data in a way that the sensor data contains at least sensor data output from four light receiving elements arranged in a matrix at the center of the light receiving surface of the light receiver of the distance sensor 20, the matrix configured with two rows in the lateral direction and two columns in the longitudinal direction. When the sensor data output from the light receiving elements disposed at the periphery of the light receiving surface are used, an obstacle may prevent highly accurate depth information DI from being produced. The controller 70 therefore acquires the sensor data in a way that the sensor data contains at least sensor data output from the four light receiving elements arranged in a matrix at the center of the light receiving surface of the light receiver 23, the matrix configured with two rows in the lateral direction and two columns in the longitudinal direction. In the provisional calculation, the controller 70 may instead acquire the sensor data output by all the light receiving elements provided in the light receiver 23.

The controller 70 then determines the normal vector N1 with respect to the projection receiving surface 3 by using the acquired sensor data. For example, the controller 70 estimates the projection receiving surface 3 by using the least squares method.

Since an obstacle may be present in the measurement area of the distance sensor 20 as described above, the normal vector N1 with respect to the projection receiving surface 3 may be determined by using the least-squares method after removing outliers from the distances indicated by the depth information DI by using random sample consensus (RANSAC).

The normal vector N1 with respect to the projection receiving surface 3 is derived from the coefficients of the equation of the plane containing the projection receiving surface 3.

The equation of the plane containing the projection receiving surface 3 and the normal vector N1 are as follows:

a1x+b1y+c1z+d1=0 (1)

N1=(a1,b1,c1) (2)

The controller 70 then selects light receiving elements to be used for the final calculation of the normal vector with respect to the projection receiving surface 3 by using the normal vector N1, which is expressed as Expression (2) with respect to the plane containing the projection receiving surface 3. The light receiving elements selected in this process are those satisfying a first condition.

In detail, light receiving elements that receive reflected light incident on the projection receiving surface 3 at a small angle of incidence are selected. Specifically, the controller 70 normalizes a direction vector Vn indicating a light reception angle at which the reflected light is received by each of the light receiving elements, normalizes the provisionally calculated normal vector N1, and determines the inner product of the normalized direction vector Vn and normal vector N1.

The direction vector Vn, which indicates the light reception angle at which the reflected light is received by each of the light receiving elements, is an example of a parameter related to the reflected light received by the light receiving regions. The normal vector N1 is an example of a parameter related to the projection receiving surface.

Expression (3) shows the direction vector Vn, Expression (4) shows the normalized direction vector Vn, and Expression (5) shows the normalized normal vector N1. Expression (6) shows the inner product of the normalized direction vector Vn and the normal vector N1. The value of the direction vector Vn is information that can be acquired from the distance sensor 20.

$$Vn = ( xn , y , zn ) \qquad ( 3 )$$

$$\frac{Vn}{\vert Vn \vert} = ( \frac{{x}_{n}}{\sqrt{{x}_{n}^{2} + {y}_{n}^{2} + {z}_{n}^{2}}} , \frac{{y}_{n}}{\sqrt{{x}_{n}^{2} + {y}_{n}^{2} + {z}_{n}^{2}}} , \frac{{z}_{n}}{\sqrt{{x}_{n}^{2} + {y}_{n}^{2} + {z}_{n}^{2}}} ) \qquad ( 4 )$$

$$\frac{{N}_{1}}{\vert {N}_{1} \vert} = ( \frac{{a}_{1}}{\sqrt{{a}_{1}^{2} + {b}_{1}^{2} + {c}_{1}^{2}}} , \frac{{b}_{1}}{\sqrt{{a}_{1}^{2} + {b}_{1}^{2} + {c}_{1}^{2}}} , \frac{{c}_{1}}{\sqrt{{a}_{1}^{2} + {b}_{1}^{2} + {c}_{1}^{2}}} ) \qquad ( 5 )$$

$$\frac{{N}_{1}}{\vert {N}_{1} \vert} \cdot \frac{Vn}{\vert Vn \vert} = \frac{\vert {N}_{1} \vert \vert Vn \vert cos ( γ )}{\vert {N}_{1} \vert \vert Vn \vert} = cos ( γ ) \qquad ( 6 )$$

An angle γ is an angle between the normal vector N1 with respect to the projection receiving surface 3 and the direction vector Vn. The controller 70 calculates the value of cos (γ) shown in Expression (6), and compares the calculated value with a first threshold. A case where the value of cos(γ) is greater than or equal to the first threshold corresponds to a case where the first condition is satisfied. The controller 70 selects light receiving elements that output sensor data showing that the calculated value of cos(y) is greater than or equal to the first threshold as the light receiving elements to be used in the final calculation of the normal vector N2 with respect to the projection receiving surface 3. When there is no light receiving element that outputs sensor data showing that the calculated value of cos(y) is greater than or equal to the first threshold, or when the number of the light receiving elements that satisfy the condition described above is smaller than a predetermined value, the controller 70 may select light receiving elements again, calculate the value of cos(γ) based on Expressions (3) to (6) described above, and compare the calculated value of cos(γ) with the first threshold again. When the value of cos(γ) is greater than or equal to the first threshold, the value of the angle γ between the normal vector N1 and the direction vector Vn decreases.

Another method for selecting light receiving elements to be used in the final calculation of the normal vector with respect to the projection receiving surface 3 will next be described. The other method is a method for simplistically selecting light receiving elements to be used in the final calculation, and the method determines the yaw angle around the Y-axis and the pitch angle around the X-axis based on the normal vector N1, and evaluates whether the determined angles are greater than an angular threshold set in advance.

Expression (7) shows a yaw angle θ, and Expression (8) shows a pitch angle φ.

$$θ = {tan}^{- 1} ( \frac{{a}_{1}}{{c}_{1}} ) \qquad ( 7 )$$

$$φ = {tan}^{- 1} ( \frac{{b}_{1}}{{c}_{1}} ) \qquad ( 8 )$$

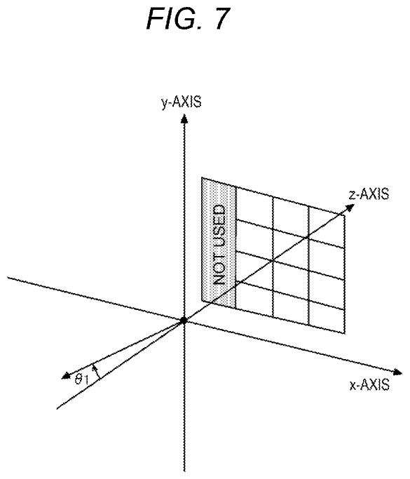

FIG. 7 shows a state in which the normal vector N1 with respect to the projection receiving surface 3 is rotated clockwise by “θ1” in the horizontal direction with respect to the optical axis of the first projection apparatus 1A. In the present embodiment, the description will be made on the assumption that the value “θ1” is 5 degrees. When the controller 70 determines based on the value of the yaw angle θ calculated by Expression (7) described above that the optical axis of the first projection apparatus 1A inclines by θ1=5 degrees with respect to the normal vector N1 with respect to the projection receiving surface 3, the controller 70 uses ¾ of the entire light receiving elements from the right side of the light receiving surface of the light receiver 23 and does not use ¼ of the entire light receiving elements on the left side of the light receiving surface of the light receiver 23, as shown in FIG. 7.

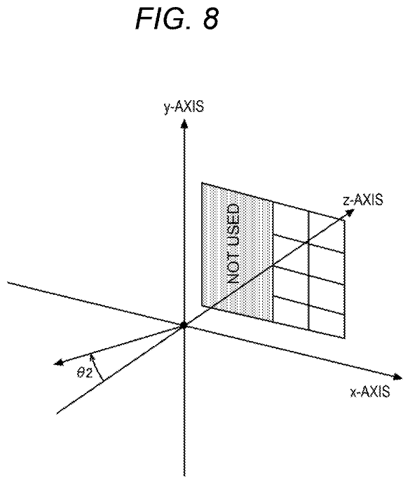

FIG. 8 shows a state in which the normal vector N1 with respect to the projection receiving surface 3 is rotated clockwise by “θ2” in the horizontal direction with respect to the optical axis of the first projection apparatus 1A. θ2 is greater than θ1. In the present embodiment, the description will be made on the assumption that the value “θ2” is 10 degrees. When the controller 70 determines based on the value of the yaw angle θ calculated by Expression (7) described above that the optical axis of the first projection apparatus 1A inclines by θ2=10 degrees with respect to the normal vector N1 with respect to the projection receiving surface 3, the controller 70 uses the light receiving elements in the right half of the light receiving surface of the light receiver 23 and does not use the light receiving elements in the left half of the light receiving surface of the light receiver 23, as shown in FIG. 8.

In the calculation of the normal vector N1, when outliers are removed, for example, by RANSAC, light receiving elements are reselected not to include those determined to output outlier depth information DI.

Also when the normal vector is calculated based on the depth information DI from the reselected light receiving elements, outliers are removed by RANSAC, and then the projection receiving surface 3 is estimated by using the least squares method. A normal vector calculated based on the depth information DI from the reselected light receiving elements is referred to as N2. When the determined normal vector N2 and the initial normal vector N1 greatly differ in direction from each other, the reselected light receiving elements may not provide depth information containing a measured distance to the projection receiving surface 3, so that the accuracy of the normal vector N2 can be improved by comparing the normal vector N1 and the normal vector N2 with each other and ascertaining that the result of the comparison shows no difference greater than or equal to a certain value.

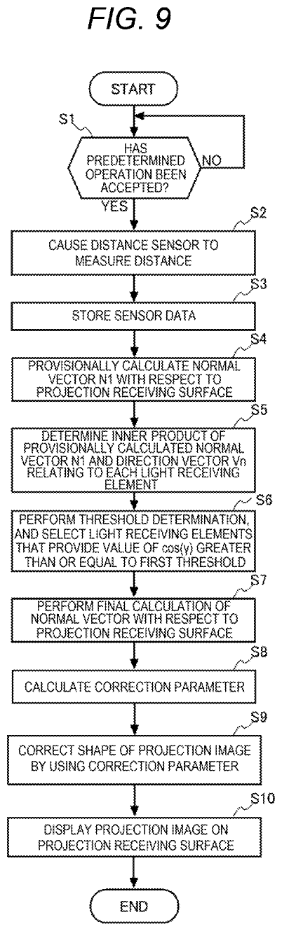

FIG. 9 is a flowchart showing the operation of the first projection apparatus 1A.

The operation of the first projection apparatus 1A will be described with reference to the flowchart shown in FIG. 9.

The controller 70 first determines whether it has accepted a predetermined operation (step S1). For example, the user presses a predetermined button with which the remote control 45 is provided to cause the first projection apparatus 1A to perform shape correction. When the predetermined button of the remote control 45 is pressed and an operation signal corresponding to the operation of the predetermined button is input via the remote control light receiver 40, the controller 70 determines that it has accepted the predetermined operation. When the controller 70 has not accepted the predetermined operation (NO in step S1), the controller 70 waits until it accepts the predetermined operation.

Having accepted the predetermined operation (YES in step S1), the controller 70 causes the distance sensor 20 to measure the distance to the projection receiving surface 3 multiple times (step S2), and causes the storage 80 to store the sensor data input from the distance sensor 20 (step S3).

The controller 70 then acquires the sensor data from the storage 80, and provisionally calculates the normal vector N1 with respect to the projection receiving surface by using the depth information DI contained in the acquired sensor data (step S4).

The controller 70 then normalizes the normal vector N1 and the direction vector Vn in accordance with Expressions (4) and (5) described above, and calculates the inner product of the normalized normal vector N1 and direction vector Vn (step S5).

The controller 70 then performs threshold determination in which cos(γ), which is the value of the inner product calculated in step S5, is compared with the first threshold. The controller 70 selects light receiving elements that each provide cos(γ) having a value greater than or equal to the first threshold (step S6).

The controller 70 then performs the final calculation of the normal vector N2 with respect to the projection receiving surface (step S7) by using the depth information DI in the sensor data output by the light receiving elements selected in step S6.

The controller 70 then uses the calculated normal vector N2 to generate correction parameters used to correct the shape of a projection image to be projected onto the projection receiving surface 3 (step S8). Having generated the correction parameters, the controller 70 corrects the shape of the projection image by using the generated correction parameters (step S9), and displays the projection image having the corrected shape on the projection receiving surface 3 (step S10).

### 3. Second Embodiment

A second embodiment will next be described.

The configuration of a first projection apparatus 1A according to the second embodiment is the same as the configuration of the first projection apparatus 1A according to the first embodiment shown in FIG. 1, and will therefore not be described.

The first projection apparatus 1A according to the second embodiment causes the distance sensor 20 to measure the distances to the multiple positions on the projection receiving surface 3 multiple times. The distances measured multiple times are then compared with a third threshold, and light receiving elements to be used in the final calculation of the normal vector are selected. When the distances measured multiple times are smaller than the third threshold, it is determined that a third condition is satisfied.

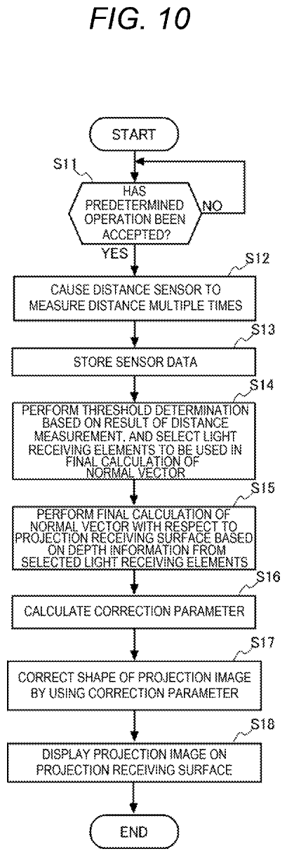

The operation of the first projection apparatus 1A according to the second embodiment will be described with reference to the flowchart shown in FIG. 10. In the flowchart shown in FIG. 10, the operation in step S11 is the same as that in step S1 of the flowchart of the first operation shown in FIG. 9, and therefore will not be described in detail.

The controller 70 causes the distance sensor 20 to measure the distance to the projection receiving surface 3 multiple times (step S12). The controller 70 causes the storage 80 to store the sensor data measured by the distance sensor 20 (step S13).

The controller 70 then acquires the sensor data from the storage 80, and selects light receiving elements satisfying the third condition based on the depth information DI indicated by the sensor data acquired to be used in the final calculation of the normal vector N2 (step S14).

For example, the controller 70 performs scale conversion on distance information indicated by the depth information DI in accordance with Expression (9).

$${d}_{ij}^{′} = \frac{{d}_{ij}}{{d}_{m i n}} \qquad ( 9 )$$

In Expression (9), dmin represents a minimum value of the depth information DI from all the light receiving elements.

“dij” represents the depth information DI at each of the pixels before the scale conversion, and “d'ij” is the depth information DI at each of the pixels after the scale conversion. The controller 70 compares the scale-converted distance information DI with the third threshold. The third threshold is assumed to be, for example, “1.3”.

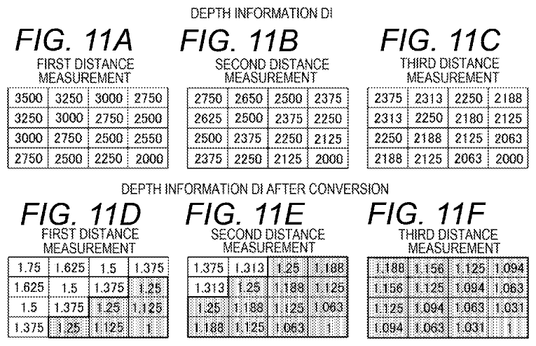

FIG. 11A shows the depth information DI obtained by the first distance measurement performed by the distance sensor 20. FIG. 11B shows the depth information DI obtained by the second distance measurement performed by the distance sensor 20. FIG. 11C shows the depth information DI obtained by the third distance measurement performed by the distance sensor 20.

FIG. 11D shows the values of the depth information DI shown in FIG. 11A after the scale conversion. FIG. 11E shows the values of the depth information DI shown in FIG. 11B after the scale conversion. FIG. 11F shows the values of the depth information DI shown in FIG. 11C after the scale conversion.

To simplify the description, FIGS. 11A to 11C show the distance sensor 20 having a configuration in which four light receiving elements are regularly arranged in each of the x-axis direction and the y-axis direction, and the distance sensor 20 may have a configuration in which six light receiving elements are regularly arranged in each of the x-axis direction and the y-axis direction, as in the first embodiment.

Hatched regions in FIGS. 11D, 11E, and 11F indicate the depth information DI after scale conversion and having values smaller than “1.3”, which is the third threshold.

The controller 70 selects light receiving elements that provide values of the depth information DI after the scale conversion all smaller than the third threshold of “1.3”, for example, in the three measurements as the light receiving elements satisfying the third condition, that is, the light receiving elements to be used in the final calculation of the normal vector N2 with respect to the projection receiving surface 3. The controller 70 may instead select light receiving element that provides an average of the depth information DI after the scale conversion as a result of the three measurements smaller than the third threshold of “1.3” as the light receiving element to be used in the final calculation of the normal vector N2 with respect to the projection receiving surface 3.

Having selected the light receiving elements to be used in the final calculation of the normal vector N2 in step S14, the controller 70 performs the final calculation of the normal vector with respect to the projection receiving surface 3 by using the depth information DI from the selected light receiving elements (step S15). The controller 70 then uses the calculated normal vector N2 to generate the correction parameters used to correct the shape of the projection image to be projected onto the projection receiving surface 3 (step S16). Having generated the correction parameters, the controller 70 corrects the shape of the projection image by using the generated correction parameters (step S17), and displays the projection image having the corrected shape on the projection receiving surface 3 (step S18).

As described above, in the second embodiment, approximate inclination of the projection receiving surface 3 can be determined only from the depth information DI, and light receiving elements that perform measurement with high accuracy can be selected without estimating the angle or the posture of the projection receiving surface 3. When the minimum value is an outlier, there is a possibility of selection of a wrong light receiving element. To avoid the wrong selection, light receiving element selection determination may be performed after outlier processing is performed in advance from the depth information DI acquired from the distance sensor 20 or information obtained from the scale conversion.

In the second embodiment, light receiving elements used in the final calculation of the normal vector N2 with respect to the projection receiving surface 3 are selected by using the depth information DI output by the distance sensor 20, but light receiving elements used in the final calculation of the normal vector N2 with respect to the projection receiving surface 3 may be selected by using the intensity information SI output by the distance sensor 20. For example, light receiving elements that output intensity information SI showing an intensity greater than a second threshold may be selected as the light receiving elements to be used in the final calculation of the normal vector N2 with respect to the projection receiving surface 3. In this case, the case where the intensity shown by the intensity information SI is greater than the second threshold corresponds to a case where a second condition is satisfied.

### 4. Third Embodiment

A third embodiment will next be described.

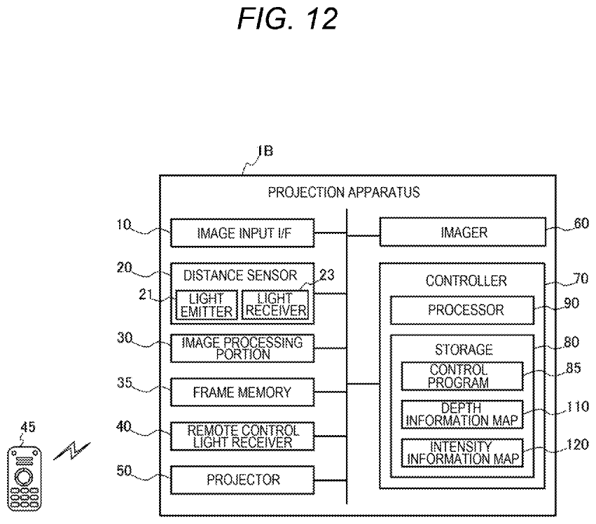

FIG. 12 is a block diagram showing the configuration of a second projection apparatus 1B according to the third embodiment.

The second projection apparatus 1B according to the third embodiment includes an imager 60. The imager 60 is, for example, a digital camera including an imaging element such as a charge coupled device (CCD) or a complementary metal oxide semiconductor (CMOS) device. The imager 60 may be configured with a stereo camera. The imager 60 images a range containing the projection receiving surface 3 to generate a captured image containing a test pattern 100 to be projected onto the projection receiving surface 3 by the projector 50. The imager 60 outputs the generated captured image to the controller 70.

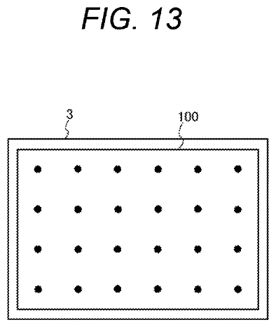

FIG. 13 shows an example of the test pattern 100.

The test pattern 100 shown in FIG. 13 is a pattern image in which four dots and six dots are arranged at equal intervals in the longitudinal direction and in the lateral direction of the projection receiving surface 3, respectively.

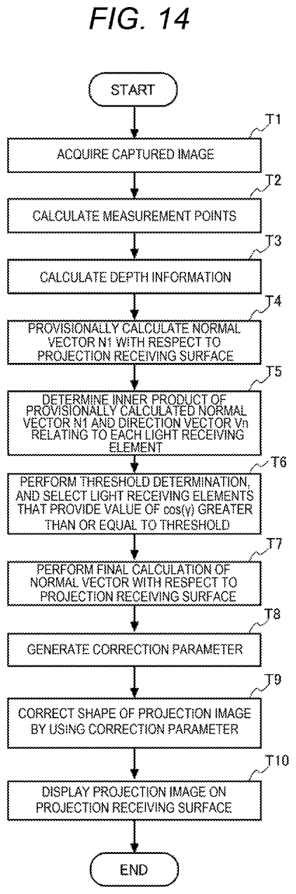

FIG. 14 is a flowchart showing the operation of the second projection apparatus 1B.

The operation of the second projection apparatus 1B will be described with reference to the flowchart shown in FIG. 14.

The controller 70 acquires a captured image of the test pattern 100 from the imager 60 (step T1).

The controller 70 then performs discretization on the acquired captured image to calculate measurement points in the captured image (step T2). The discretization used herein is, for example, the process of scanning a two-dimensional plane containing the captured image in the x-axis direction and the y-axis direction, determining a pixel density distribution, determining four centroid positions in the x-axis direction and six centroid positions in the y-axis direction from the density distribution, and acquiring the center coordinates of each dot region in the captured image. The measurement points in the captured image correspond to the center coordinates of the dot regions in the captured image.

The controller 70 then calculates the depth information DI by using an active stereo method (step T3) based on the measurement points in the captured image, the three-dimensional coordinates of the dots corresponding to the measurement points in the lens coordinate system of the second projection apparatus 1B, and the relative coordinates of the second projection apparatus 1B in the imager coordinate system with respect to the lens coordinate system of the second projection apparatus 1B.

The depth information DI is information on the distances between the second projection apparatus 1B and the dots of the test pattern 100 displayed on the projection receiving surface 3. As a method for calculating the depth information DI, a method other than the active stereo method, such as a passive stereo method using multiple cameras, may be used to detect the three-dimensional coordinates of the measurement point.

The controller 70 then provisionally calculates the normal vector N1 with respect to the projection receiving surface 3 by using the calculated depth information DI (step T4).

The controller 70 then normalizes the normal vector N1 and the direction vector Vn in accordance with Expressions (4) and (5) described above, and determines the inner product of the normalized normal vector N1 and direction vector Vn (step T5).

The controller 70 then performs the threshold determination, in which cos(γ), which is the value of the inner product calculated in step T5, is compared with a threshold. The controller 70 selects light receiving elements that each provide cos(γ) having a value greater than or equal to the threshold (step T6).

The controller 70 then performs the final calculation of the normal vector N2 with respect to the projection receiving surface (step T7) by using the depth information DI in the sensor data output by the light receiving elements selected in step T6.

The controller 70 then uses the calculated normal vector N2 to generate the correction parameters used to correct the shape of the projection image to be projected onto the projection receiving surface 3 (step T8). Having generated the correction parameters, the controller 70 corrects the shape of the projection image by using the generated correction parameters (step T9), and displays the projection image having the corrected shape on the projection receiving surface 3 (step T10).

The embodiments described above are preferred embodiments of the present disclosure. The present disclosure is, however, not limited to the embodiments described above, and various modifications are conceivable to the extent that the modifications do not depart from the key points of the present disclosure.

For example, in the first embodiment described above, the sensor data from the light receiving elements used in the final calculation of the normal vector with respect to the projection receiving surface 3 are selected based on the relationship between the provisionally calculated normal vector N1 with respect to the projection receiving surface 3 and the angles of incidence of the reflected light incident on the light receiving elements, and the optical axis of the first projection apparatus 1A or the optical axis of the distance sensor 20 may be used in place of the angles of incidence of the reflected light incident on the light receiving elements. In this case, the light receiving elements used in the final calculation of the normal vector with respect to the projection receiving surface 3 are selected based on the relationship between the provisionally calculated normal vector N1 with respect to the projection receiving surface 3 and the optical axis of the first projection apparatus 1A or the optical axis of the distance sensor 20.

FIG. 13 shows a dot pattern as the test pattern 100, and the test pattern 100 may be a checkerboard pattern or a phase shift pattern.

In the first to third embodiments described above, the case where the transmissive liquid crystal panels are provided as the light modulators is presented by way of example, and the liquid crystal panels may instead be reflective liquid crystal panels. The light modulators may each have a configuration in which the liquid crystal panel is replaced with a digital mirror device. The light modulators may have a configuration in which the digital mirror devices and a color wheel are combined with each other. Besides the liquid crystal panels and the digital mirror devices, the light modulators may each have a configuration capable of modulating the light output by a light source.

Each of the functional portions of the first projection apparatus 1A shown in FIG. 1 and the second projection apparatus 1B shown in FIG. 12 shows a functional configuration, and is not necessarily implemented in a specific form. That is, hardware individually corresponding to each of the functional portions is not necessarily required to be implemented, and a configuration in which one processor executes a program to realize the functions of multiple functional portions can, of course, be employed. Some of functions realized by software in the embodiments described above may be realized by hardware, and some of functions realized by hardware in the embodiments may be realized by software. In addition, the specific detailed configuration of each of the other portions of the projector can be freely changed to the extent that the change does not depart from the intent of the present disclosure.

The procedure of each of the flowcharts shown in FIGS. 9 and 10 has been divided into process units in accordance with primary process contents to facilitate understanding of the processes carried out by the first projection apparatus 1A. The present disclosure is not limited by how to divide the process units and the names thereof shown in the flowcharts shown in FIGS. 9 and 10. A process carried out by the first projection apparatus 1A can be further divided into a larger number of process units in accordance with the content of the process, and the process units can each further be divided into a large number of processes. Furthermore, the process orders of the flowcharts described above are not limited to those shown in the figures. The same applies to the flowchart showing the operation of the second projection apparatus 1B shown in FIG. 14.

In the first embodiment, the direction vector Vn indicating the light reception angle of the reflected light received by each of the light receiving elements is used as an example of the parameter related to the projection receiving surface as an example of the parameter related to the reflected light received by the light receiving regions, but the parameter related to the reflected light received by the light receiving regions is a parameter related to the posture of the reflected light, and the parameter related to the projection receiving surface is not limited to the parameter described above, and may be any parameter related to the orientation of the projection receiving surface.

Specifically, the parameter related to the reflected light received by the light receiving regions is a direction vector of the reflected light, the light reception angle of the reflected light, a rotation matrix representing rotation in the direction of the reflected light, a rotation vector, the axis of rotation and the angle of rotation, a quaternion, or the like, and the parameter related to the projection receiving surface is an angle of the projection receiving surface in the lens coordinate system of the projection apparatus, a rotation matrix representing rotation to the projection receiving surface, a rotation vector, the axis of rotation and the angle of rotation, a quaternion of the projection receiving surface, the equation of the projection receiving surface, or the like.

### 5. Summary of Present Disclosure

The present disclosure will be summarized below in the form of additional remarks.

### Additional Remark 1

A method for correcting a projection image to be projected by a projection apparatus onto a projection receiving surface, the method including: acquiring depth information indicating a distance from a distance sensor to each of multiple positions on the projection receiving surface based on an output from the distance sensor, the distance sensor including a light emitter configured to irradiate the projection receiving surface with radiation light and a light receiver having multiple light receiving regions configured to receive reflected light that is the radiation light reflected off the projection receiving surface; selecting at least one of the multiple light receiving regions based on the depth information; generating a parameter that specifies the projection receiving surface based on the depth information provided when the selected light receiving region receives the reflected light; and correcting the projection image based on the parameter that specifies the projection receiving surface.

In the correction method according to Additional Remark 1, at least one of the multiple light receiving regions is selected based on the depth information, and the parameter that specifies the projection receiving surface is generated based on the depth information provided when the selected light receiving region receives the reflected light. The projection image is then corrected based on the generated parameter. The correction method described above, in which a light receiving region is selected based on the distances from the distance sensor to the multiple positions on the projection receiving surface, can prevent a light receiving region where the distance measurement accuracy is low from being selected. The projection image can therefore be accurately corrected by generating a parameter that specifies the projection receiving surface based on the depth information provided when the selected light receiving region receives the reflected light and correcting the projection image based on the generated parameter.

### Additional Remark 2

The correction method according to Additional Remark 1, wherein selecting at least one of the multiple light receiving regions includes calculating the parameter related to the projection receiving surface based on the depth information, and selecting at least one of the multiple light receiving regions based on a parameter related to the reflected light received by the light receiving regions and the parameter related to the projection receiving surface.

In the correction method according to Additional Remark 2, at least one of the multiple light receiving regions is selected based on the parameter related to the reflected light received by the light receiving regions and the parameter related to the projection receiving surface. The correction method described above can prevent a light receiving region where the measurement accuracy is low from being selected.

### Additional Remark 3

The correction method according to Additional Remark 2, wherein the parameter related to the projection receiving surface is a normal vector with respect to the projection receiving surface, the parameter related to the reflected light received by the light receiving regions is direction vectors of the reflected light received by the light receiving regions, and selecting at least one of the multiple light receiving regions includes calculating angles between the direction vectors and the normal vector, and selecting the light receiving region corresponding to a position on the projection receiving surface at which the calculated angle satisfies a first condition.

In the correction method according to Additional Remark 3, the angles between the reflected light incident on and received by the light receiving regions and the normal vector with respect to the projection receiving surface are calculated, and the light receiving region corresponding to the position on the projection receiving surface at which the calculated angle satisfies the first condition is selected. The correction method described above can prevent a light receiving region where the angle between the projection receiving surface and the distance sensor is large from being selected. The projection image can therefore be accurately corrected by generating a parameter that specifies the projection receiving surface based on the depth information provided when the selected light receiving region receives the reflected light and correcting the projection image based on the generated parameter.

### Additional Remark 4

The correction method according to Additional Remark 1, wherein selecting at least one of the multiple light receiving regions includes acquiring multiple pieces of intensity information indicating intensities of the reflected light at the multiple positions, and selecting a light receiving region that outputs the intensity information showing that the intensity satisfies a second condition out of the multiple pieces of acquired intensity information.

In the correction method according to Additional Remark 4, the multiple pieces of intensity information indicating the intensities of the reflected light at the multiple positions are acquired, and a light receiving region that outputs the intensity information showing that the intensity satisfies the second condition is selected out of the multiple pieces of acquired intensity information. The correction method described above can prevent a light receiving region where the distance between the projection receiving surface and the distance sensor is large from being selected. The projection image can therefore be accurately corrected by generating a parameter that specifies the projection receiving surface based on the depth information provided when the selected light receiving region receives the reflected light and correcting the projection image based on the generated parameter.

### Additional Remark 5

The correction method according to Additional Remark 1, wherein selecting at least one of the multiple light receiving regions includes selecting the light receiving region corresponding to a position on the projection receiving surface at which the distance from the distance sensor to a corresponding one of the multiple positions on the projection receiving surface satisfies a third condition.

In the correction method according to Additional Remark 5, the light receiving region corresponding to a position on the projection receiving surface at which the distance from the distance sensor to a corresponding one of the multiple positions on the projection receiving surface satisfies the third condition is selected. The correction method described above, in which a light receiving region is selected based on the distances from the distance sensor to the multiple positions on the projection receiving surface, can prevent a light receiving region where the distance measurement accuracy is low from being selected. The projection image can therefore be accurately corrected by generating a parameter that specifies the projection receiving surface based on the depth information provided when the selected light receiving region receives the reflected light and correcting the projection image based on the generated parameter.

### Additional Remark 6

A method for correcting a projection image to be projected by a projection apparatus onto a projection receiving surface, the method including: projecting the projection image containing a test pattern onto the projection receiving surface via the projection apparatus; selecting at least one pattern contained in the test pattern based on an image captured by an imaging apparatus configured to capture an image of the projection receiving surface onto which the projection image containing the test pattern is projected; acquiring depth information indicating a distance to the projection receiving surface based on a position of a light receiving element configured to capture an image of the selected pattern out of light receiving elements provided in an imager of the imaging apparatus; generating a parameter that specifies the projection receiving surface based on the depth information; and correcting the projection image based on the parameter that specifies the projection receiving surface.

In the correction method according to Additional Remark 6, at least one pattern contained in the test pattern is selected based on the image captured by the imaging apparatus that captures an image of the projection image containing the test pattern, and the depth information indicating the distance to the projection receiving surface is acquired based on the position of the light receiving element that captures an image of the selected pattern. A parameter that specifies the projection receiving surface is then generated based on the acquired depth information, and the projection image is corrected based on the generated parameter. The correction method can therefore prevent selection of a light receiving region where the distance measurement accuracy is low. The projection image can therefore be accurately corrected by generating a parameter that specifies the projection receiving surface based on the depth information provided when the selected light receiving region receives the reflected light and correcting the projection image based on the generated parameter.

### Additional Remark 7

A projection apparatus including: a projector configured to project a projection image onto a projection receiving surface; and one or more processors, wherein the one or more processors are configured to acquire depth information indicating a distance from a distance sensor to each of multiple positions on the projection receiving surface based on an output from the distance sensor, the distance sensor including a light emitter configured to irradiate the projection receiving surface with radiation light and a light receiver having multiple light receiving regions configured to receive reflected light that is the radiation light reflected off the projection receiving surface; select at least one of the multiple light receiving regions based on the depth information; generate a parameter that specifies the projection receiving surface based on the depth information provided when the selected light receiving region receives the reflected light; and correct the projection image based on the parameter that specifies the projection receiving surface.

The projection apparatus according to Additional Remark 7 provides the same advantages as the correction method according to Additional Remark 1.

### Additional Remark 8

A projection apparatus including: a projector configured to project a projection image onto a projection receiving surface; and one or more processors, wherein the one or more processors are configured to project the projection image containing a test pattern onto the projection receiving surface via the projection apparatus; select at least one pattern contained in the test pattern based on an output from an imaging apparatus configured to capture an image of the projection receiving surface onto which the projection image containing the test pattern is projected; acquire depth information indicating a distance to the projection receiving surface based on a position of a light receiving element configured to capture an image of the selected pattern out of light receiving elements provided in an imager of the imaging apparatus; generate a parameter that specifies the projection receiving surface based on the depth information; and correct the projection image based on the parameter that specifies the projection receiving surface.

The projection apparatus according to Additional Remark 8 provides the same advantages as the correction method according to Additional Remark 6.

What is claimed is:

1. A method for correcting a projection image to be projected by a projection apparatus onto a projection receiving surface, the method comprising:
acquiring depth information indicating a distance from a distance sensor to each of multiple positions on the projection receiving surface based on an output from the distance sensor, the distance sensor including a light emitter configured to irradiate the projection receiving surface with radiation light and a light receiver having multiple light receiving regions configured to receive reflected light that is the radiation light reflected off the projection receiving surface;
selecting at least one of the multiple light receiving regions based on the depth information;
generating a parameter that specifies the projection receiving surface based on the depth information provided when the selected light receiving region receives the reflected light; and
correcting the projection image based on the parameter that specifies the projection receiving surface.

2. The correction method according to claim 1, wherein
selecting at least one of the multiple light receiving regions includes
calculating the parameter related to the projection receiving surface based on the depth information, and
selecting at least one of the multiple light receiving regions based on a parameter related to the reflected light received by the light receiving regions and the parameter related to the projection receiving surface.

3. The correction method according to claim 2, wherein
the parameter related to the projection receiving surface is a normal vector with respect to the projection receiving surface,
the parameter related to the reflected light received by the light receiving regions is direction vectors of the reflected light received by the light receiving regions, and
selecting at least one of the multiple light receiving regions includes
calculating angles between the direction vectors and the normal vector, and
selecting the light receiving region corresponding to a position on the projection receiving surface at which the calculated angle satisfies a first condition.

4. The correction method according to claim 1, wherein
selecting at least one of the multiple light receiving regions includes
acquiring multiple pieces of intensity information indicating intensities of the reflected light at the multiple positions, and
selecting a light receiving region that outputs the intensity information showing that the intensity satisfies a second condition out of the multiple pieces of acquired intensity information.

5. The correction method according to claim 1, wherein
selecting at least one of the multiple light receiving regions includes selecting the light receiving region corresponding to a position on the projection receiving surface at which the distance from the distance sensor to a corresponding one of the multiple positions on the projection receiving surface satisfies a third condition.

6. A method for correcting a projection image to be projected by a projection apparatus onto a projection receiving surface, the method comprising:
projecting the projection image containing a test pattern onto the projection receiving surface via the projection apparatus;
selecting at least one pattern contained in the test pattern based on an image captured by an imaging apparatus configured to capture an image of the projection receiving surface onto which the projection image containing the test pattern is projected;
acquiring depth information indicating a distance to the projection receiving surface based on a position of a light receiving element configured to capture an image of the selected pattern out of light receiving elements provided in an imager of the imaging apparatus;
generating a parameter that specifies the projection receiving surface based on the depth information; and
correcting the projection image based on the parameter that specifies the projection receiving surface.

7. A projection apparatus comprising:
a projector configured to project a projection image onto a projection receiving surface; and
one or more processors,
wherein the one or more processors are configured to
acquire depth information indicating a distance from a distance sensor to each of multiple positions on the projection receiving surface based on an output from the distance sensor, the distance sensor including a light emitter configured to irradiate the projection receiving surface with radiation light and a light receiver having multiple light receiving regions configured to receive reflected light that is the radiation light reflected off the projection receiving surface;
select at least one of the multiple light receiving regions based on the depth information;
generate a parameter that specifies the projection receiving surface based on the depth information provided when the selected light receiving region receives the reflected light; and
correct the projection image based on the parameter that specifies the projection receiving surface.

8. A projection apparatus comprising:
a projector configured to project a projection image onto a projection receiving surface; and
one or more processors,
wherein the one or more processors are configured to
project the projection image containing a test pattern onto the projection receiving surface via the projection apparatus;
select at least one pattern contained in the test pattern based on an output from an imaging apparatus configured to capture an image of the projection receiving surface onto which the projection image containing the test pattern is projected;
acquire depth information indicating a distance to the projection receiving surface based on a position of a light receiving element configured to capture an image of the selected pattern out of light receiving elements provided in an imager of the imaging apparatus;
generate a parameter that specifies the projection receiving surface based on the depth information; and
correct the projection image based on the parameter that specifies the projection receiving surface.
